(19) United States
(12) Patent Application Publication
(10) Pub. No.: US 2003/0117911 A1
(43) Pub. Date: Jun. 26, 2003

(54) Pickup inspection apparatus

(75) Inventors: Shin-Kyu Park, Anyang-City (KR); Jong-Il Kee, Suwon-City (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/186,972

(22) Filed: Jul. 2, 2002

(30) Foreign Application Priority Data
Dec. 24, 2001 (KR) 2001-84394

(51) Int. Cl. G11B 7/00

(52) U.S. Cl. 369/44.27; 369/53.28

(57) ABSTRACT

A pickup inspection apparatus has a machine unit, spindle and feed motors, a servo unit, a position detection unit, a measurement unit and a control unit. In the machine unit, a pickup module to be inspected and a test disc for inspection are installed. The spindle motor is installed in the machine unit to rotate the test disc. The feed motor is installed in the machine unit to perform a tracking operation. The servo unit drives the spindle and the feed motors. The position detection unit detects a tracking position by the feed motor. The measurement unit processes signals outputted from the pickup module. The control unit controls the servo unit and the measurement unit and determines the state of the pickup module according to a measurement result of the measurement unit.

### CROSS-REFERENCE TO RELATED APPLICATION

This application claims the benefit of Korean Application No. 2001-84394, filed Dec. 24, 2001, in the Korean Intellectual Property Office, the disclosure of which is incorporated herein by reference.

### BACKGROUND OF THE INVENTION

1. Field of the Invention

The present invention relates generally to a pickup inspection apparatus.

2. Description of the Prior Art

Recently, moving picture data as well as audio data are recorded on optical discs such as an audio Compact Disc (CD). One form of the optical discs are Compact Disc-Read Only Memories (CD-ROMs) and has popular uses ranging from a use for education to a use for information access. Further, there has been recently proposed an optical disc, a so-called Digital Versatile Disc (DVD), in which moving picture data of large capacity can be stored on an optical disc with a same diameter as the conventional CD.

Additionally, systems that play a variety of optical discs and record data therein have been developed and popularized, and combo-type players capable of playing optical discs of different forms have been popularized.

Manufacturing companies produce and sell various optical disc players. In optical pickups included in such optical disc players, pickups are tested for their integrity. Only pickups passing inspection are installed as parts of optical disc players. In order to test optical pickups, various inspection devices are required. Each of the inspection devices performs the inspection corresponding to one of the kinds of optical pickups being inspected. Conventionally, the inspection devices are different according to the kinds of optical pickups. Therefore, in order to inspect combo-type optical pickups, inspections are performed for each type of optical disc to be read by the combo-type optical pickup using corresponding ones of the inspection devices. The need to repeatedly inspect using multiple inspection devices requires a great deal of inspection time and consequently increases the manufacturing cost of an apparatus to perform an inspection of the combo-type.

### SUMMARY OF THE INVENTION

Accordingly, the present invention has been made keeping in mind the above and other problems, and an object of the present invention is to provide a pickup inspection apparatus to inspect various types of optical pickups using a single inspection apparatus, and to automatically inspect a combo-type optical pickup using a single piece of equipment.

Additional objects and advantages of the invention will be set forth in part in the description which follows and, in part, will be obvious from the description, or may be learned by practice of the invention.

In order to accomplish the above and other objects, an embodiment of the present invention provides a pickup inspection apparatus comprising a machine unit in which a pickup module to be inspected and a test disc for inspection are installed, a spindle motor installed in the machine unit to rotate the test disc, a feed motor installed in the machine unit to perform a tracking operation, a servo unit to drive the spindle and the feed motors, a position detection unit to detect a tracking position of the feed motor, a measurement unit to process signals outputted from the pickup module, and a control unit to control the servo unit and the measurement unit and to determine the state of the pickup module according to a measurement result of the measurement unit.

### BRIEF DESCRIPTION OF THE DRAWINGS

The above and other objects, features and other advantages of the present invention will be more clearly understood and more readily appreciated from the following detailed description taken in conjunction with the accompanying drawings, in which:

FIG. 1 is a block diagram of a pickup inspection apparatus according to an embodiment of the present invention;

FIG. 2 is a detailed block diagram of a measuring unit of the pickup inspection apparatus of FIG. 1; and

FIG. 3 is a flowchart showing the operation of the pickup inspection apparatus of FIG. 1.

### DESCRIPTION OF THE EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

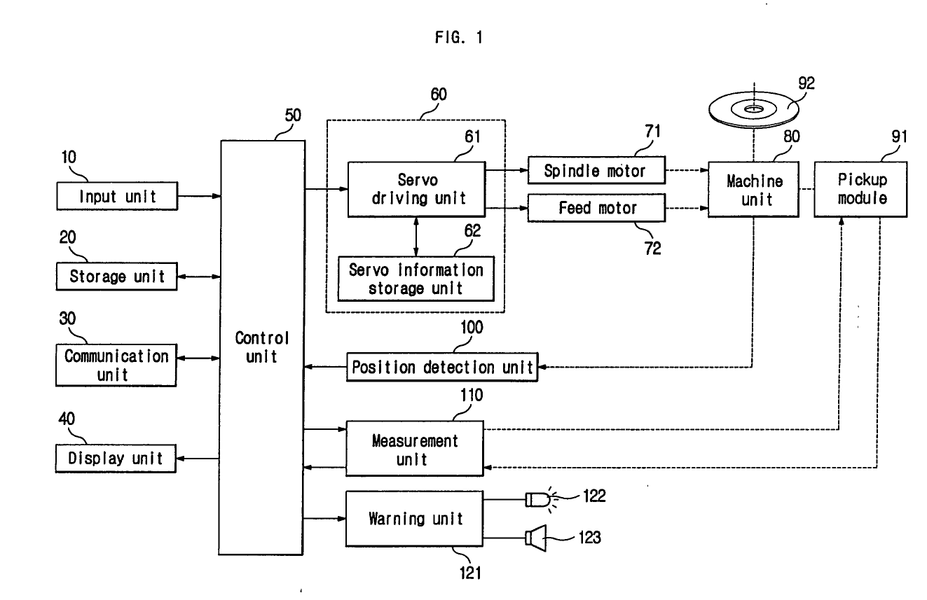

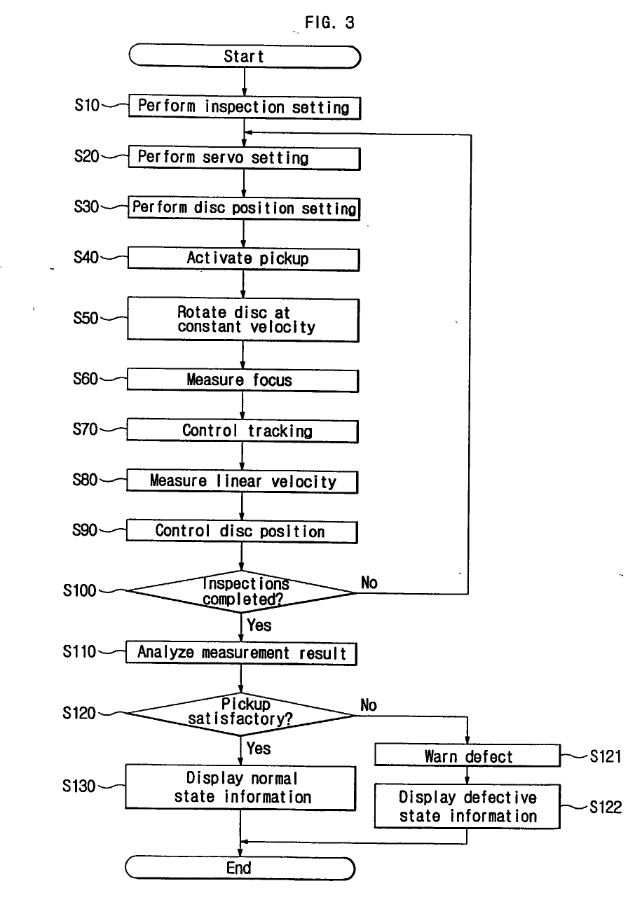

FIG. 1 is a block diagram of a pickup inspection apparatus according to an embodiment of the present invention. Referring to FIG. 1, the pickup inspection apparatus of this invention comprises a control unit 50 to control the entire operation of the inspection apparatus. Connected to the control unit 50 are an input unit 10 to receive operation commands from a user, a storage unit 20 to store data, a communication unit 30 to communicate with the user or an external device, and a display unit 40 to display operation information. According to an embodiment of the invention, the control unit 50, as well as ones of the input unit 10, the storage unit 20, the communication unit 30 and the display unit 40 which are connected to the control unit 50 are a computer performing the operations such as that shown in FIG. 3, where the operations are encoded on a computer readable medium to be performed by the computer. It is understood that the computer can be a general purpose computer, a personal computer, or a special purpose computer according to embodiments of the invention.

The pickup inspection apparatus includes a machine unit 80 in which a pickup module 91 and a test disc 92 are installed. A spindle motor 71 is installed in the machine unit 80 to rotate the test disc 92. A feed motor 72 is also installed in the machine unit 80 to perform a tracking operation. The spindle motor 71 and the feed motor 72 are driven under the control of a servo unit 60. The servo unit 60 includes a servo driving unit 61 connected to the control unit 50, and a servo information storage unit 62 to store servo information provided from the control unit 50.

The pickup module 91 is realized as a combo-type pickup module in which a first optical pickup to read data from a compact disc (CD) and a second optical pickup to read data from a digital versatile disc (DVD) are formed in a single pickup module 91. The pickup module 91 can be constructed in various types such as DVD/CD-RW (rewritable) combo as well as CD/DVD combo. However, it is understood that various combinations of optical disc compatible optical pickups can be combined to form the pickup module 91.

Further, the pickup inspection apparatus comprises a position detection unit 100 installed at a portion of the machine unit 80 and connected to the control unit 50 so as to detect the position of the test disc 92 or the pickup module 91 tracked by the feed motor 72.

Moreover, a measurement unit 110 to drive the pickup module 91 is connected to the control unit 50. A warning unit 121 to provide a visual warning through a lamp 122 and an auditory warning though a speaker 123 is connected to the control unit 50.

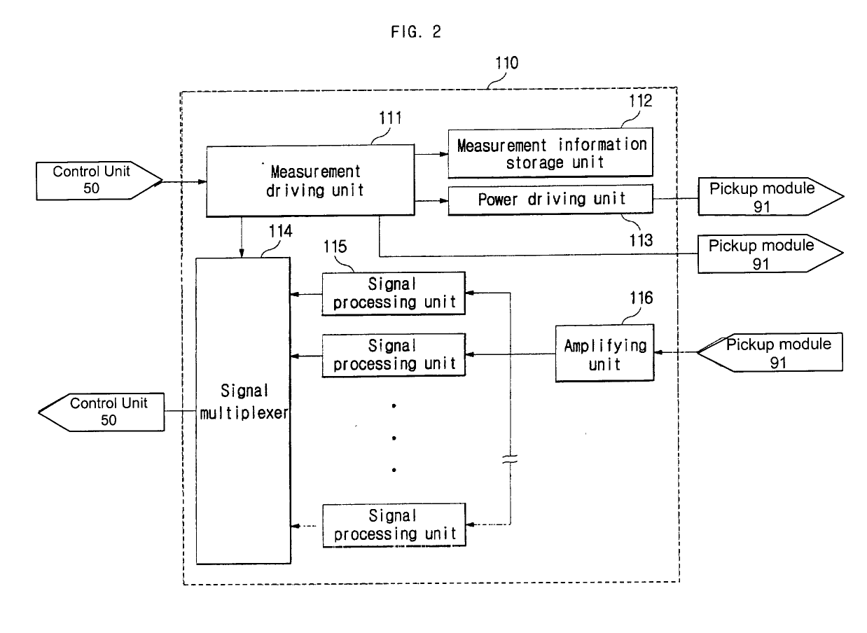

FIG. 2 is a detailed block diagram showing the measurement unit 110 of the pickup inspection apparatus. Referring to FIG. 2, the measurement unit 110 includes a measurement driving unit 111 connected to the control unit 50 to receive control information to perform the measurement operations. Further, a measurement information storage unit 112 stores information provided from the control unit 50 and is connected to the measurement driving unit 111. A power driving unit 113 controls power supplied to the pickup module 91 and is controlled by the measurement driving unit 111. Further, the measurement unit 110 includes an amplifying unit 116 to amplify a signal outputted from the pickup module 91, a plurality of signal processing units 115 to process the signal amplified by the amplifying unit 116, and a signal multiplexer 114 to selectively output signals of the signal processing units 115 to the control unit 50 under the control of the measurement driving unit 111.

Hereinafter, the operation of the pickup inspection apparatus of this invention is described in detail using FIG. 3. FIG. 3 is a flowchart showing the operation of the pickup inspection apparatus of this invention. In this flowchart of this invention, a process of first inspecting an optical pickup for a DVD and next inspecting an optical pickup for a CD in the pickup module 91 is disclosed. However, it is understood that the order of inspection can be reversed, and can also be modified to inspect other types of discs with which the pickup module 91 is compatible.

First, an inspection setting is performed to inspect pickups at operation S10. In order to perform the inspection setting, an inspector installs the pickup module 91 and the test disc 92 in the machine unit 80. Further, the inspector can input an inspection sequence and various parameters through the input unit 10, load preset inspection information files stored in the storage unit 20, or receive the inspection information files from a remote place through the communication unit 30. In the shown embodiment, the inspection information files include information related to measurement and information related to servo control. Here, the information related to the measurement includes an operation sequence, measurement setting values used to set a number of measurements and an intensity of a voltage, and correction values. Further, the information related to the servo control is downloaded via communication during the driving of the pickup module 91.

After operation S10, the control unit 50 sends servo information on an optical pickup to be inspected according to the inspection information to the servo driving unit 61 of the servo unit 60. At this time, the servo information is the information set to correspond to the second optical pickup for a DVD, and includes information on an intensity of a laser and focus information for use in the pickup module 91, tracking information for use by the feed motor 72, and linear velocity information for use by the spindle motor 71. Accordingly, the servo driving unit 61 performs servo setting by storing information provided from the control unit 50 in the servo storage unit 62 (operation S20).

After performing servo setting at operation S20, the servo driving unit 61 drives the feed motor 72 to operate the machine unit 80 so as to position the pickup module 91 at a DVD area of the test disc 92. Specifically, the position detection unit 100 detects the position of the machine unit 80 driven by the feed motor 72 and transmits the detected result to the control unit 50. If, using the detected position, the control unit 50 determines that the pickup module 91 is positioned at the DVD area of the test disc 92, the control unit 50 transmits a feed stop signal to the servo driving unit 60. Accordingly, the servo driving unit 61 stops the operation of the feed motor 72. Then, the position setting of the pickup module 91 and the test disc 92 is completed (operation S30).

After performing operation S30, the control unit 50 outputs a start signal to the measurement unit 110 to perform the inspection. Then, the measurement driving unit 111 of the measurement unit 110 controls the power driving unit 113 to supply power to the pickup module 91, and to activate the second optical pickup for a DVD in pickup module 91 (operation S40). Further, the control unit 50 transmits a disc rotation signal to the servo driving unit 61. The servo driving unit 61 rotates the spindle motor 71 at constant velocity for a set number of revolutions according to information stored in the servo information storage unit 62 (operation S50).

The pickup module 91 obtains a signal by reading the test disc 92 and outputs the obtained signal to the amplifying unit 116. The amplifying unit 116 amplifies the obtained signal and sends the amplified signal to each of the signal processing units 115. Accordingly, each signal processing unit 115 performs a corresponding inspection procedure and also processes the focus. The measurement driving unit 111 controls the signal multiplexer 114 to transmit signals from the signal processing units 115 to the control unit 50. Then, the control unit 50 converts the signal outputted from the signal multiplexer 114 into digital data through an internal analog/digital converter (not shown), stores the data in the storage unit 20, and determines whether there is any defect in the focus on the basis of the stored data, thus completing a focus measurement (operation S60).

In order to measure a linear velocity after measuring the focus, the servo driving unit 61 performs tracking control. Specifically, the servo driving unit 61 operates the feed motor 72 to move the pickup module 91 to the outer track of the DVD area of the test disc 92 under the control of the control unit 50 (operation S70). Therefore, the position detection unit 100 detects the position of the pickup module 91 based on the track movement and transmits the detected result to the control unit 50. The control unit 50 transmits position information detected by the position detection unit 100 to the servo driving unit 61. The servo driving unit 61 controls the number of revolutions of the spindle motor to keep the same linear velocity according to the position of the track where the pickup module 91 is placed. Accordingly, the pickup module 91 reads information of the test disc 92 along the direction of the track movement, and outputs the read information to the amplifying unit 116. The signal amplified by the amplifying unit 116 is outputted to the signal processing unit 115, and the measurement driving unit 111 controls the signal multiplexer 114 to output the signals from corresponding signal processing units 115 to the control unit 50.

The control unit 50 converts the signal outputted from the signal multiplexer 114 into digital data through the internal analog/digital converter and stores the converted data in the storage unit 20. Then, the control unit 50 determines on the basis of the stored data whether there is any defect in the linear velocity, thus completing a linear velocity measurement (operation S80).

If the linear velocity measurement is completed, the control unit 50 outputs a DVD measurement completion signal to the servo driving unit 61. The servo driving unit 61 controls the feed motor 72 to move the pickup module 91 to an initial position of the test disc 92 (operation S90). Then, the position detection unit 100 detects a position varied by the feed motor 72 and transmits the detected result to the control unit 50. If the control unit 50 determines that the pickup module 91 is positioned at the set position of the test disc 92, the control unit 50 controls the servo driving unit 61 to stop the operation of the feed motor 72. Then, the control unit 50 determines whether the inspections are completed (operation S100). If any one of the inspections for a DVD and a CD is not completed, the control unit 50 returns to operation S10 to perform the uncompleted inspection.

According to the present example, the control unit 50 determines that the DVD inspection is completed, but that the CD inspection is not completed. As such, in operation S10, the control unit 50 begins another inspection process to inspect the first optical pickup for a CD of the pickup module 91. After returning to operation S10 to inspect the first optical pickup for the CD, the control unit 50 repeats the same process as the second optical pickup inspection process. However, at the inspection setting operation S10, the control unit 50 inputs various parameters used to inspect the first optical pickup for a CD through the input unit 10 or loads preset inspection information files for the first optical pickup, stored in the storage unit 20. Otherwise, the control unit 50 can be provided with the inspection information for the first optical pickup from a remote place through the communication unit 30. Further, the inspection information for first optical pickup can be set together with the inspection information for the second optical pickup at the start of an inspection.

On the other hand, if the control unit 50 determines that the inspections are completed at operation S100, the control unit 50 compares measurement results stored in the storage unit 20 with preset reference data and analyzes the comparison result (operation S100). Then, the control unit 50 determines whether the inspected pickup module 91 is satisfactory according to the analysis result (operation S120).

If the control unit 50 determines that the inspected pickup module 91 is satisfactory at operation S120, the control unit 50 displays a message through the display 40 indicating that the inspected pickup module 91 is normal (operation S130). Further, the control unit 50 displays the measurement result data stored in the storage unit 20 on the display unit 40.

However, if the control unit 50 determines that the inspected pickup module 91 is not satisfactory at operation 120, the control unit 50 drives the warning unit 121 to provide a visual warning through the lamp 122 and an auditory warning through the speaker 123 (operation S121). Further, the control unit 50 displays information related to a defective state, which is stored in the storage unit 20, on the display unit 40 (operation S122). It is understood that the warning unit 121 and/or the speaker 123 need not be used in all aspects of the invention, may be used individually to warn of a defective optical pickup module 91, or that other devices can inform an inspector of a defective optical pickup module 91.

As described above, the present invention provides a pickup inspection apparatus that inspects various kinds of pickups including combo-type pickups and executes various types of inspections using a single inspection apparatus, thus shortening inspection time and decreasing the manufacturing cost of the pickup inspection apparatus.

Although the embodiments of the present invention have been disclosed for illustrative purposes, those skilled in the art will appreciate that various modifications, additions and substitutions are possible, without departing from the scope and spirit of the invention as disclosed in the accompanying claims and equivalents thereof.

What is claimed is:

1. A pickup inspection apparatus to inspect a pickup module that reads multiple types of discs, comprising:
a machine unit in which the pickup module to be inspected and a test disc for inspection are installed;
a spindle motor installed in said machine unit to rotate the test disc;
a feed motor installed in said machine unit to perform a tracking operation on the test disc using the pickup module;
a servo unit to drive said spindle motor and to drive said feed motor;
a position detection unit to detect a tracking position by said feed motor;
a measurement unit to activate the pickup module to read data from the test disc and to process signals outputted from the pickup module to provide a measurement result; and
a control unit to set the pickup module to be compatible with one of the types of discs but not compatible with another of the types of discs, to control said servo unit and said measurement unit according to the set one type of disc, and to determine a state of the pickup module according to the measurement result from said measurement unit.

2. The pickup inspection apparatus according to claim 1, wherein the pickup module is a combo type module including optical pickups capable of reading corresponding ones of the kinds of optical discs, and the test disc has a divided track such that different optical pickups of the combo-type module read data from corresponding portions of the test disc.

3. The pickup inspection apparatus according to claim 1, wherein said servo unit indudes a servo driving unit to drive said spindle motor and said feed motor using servo information provided from said control unit, and a servo information storage unit to store the servo information.

4. The pickup inspection apparatus according to claim 1, wherein said position detection unit is installed in said machine unit, detects the tracking position of said feed motor, and transmits the detected result to said control unit.

5. The pickup inspection apparatus according to claim 1, wherein said measurement unit includes:
a measurement driving unit to receive control information from said control unit, the measurement driving unit to perform measurement operations according to the received control information,
a measurement information storage unit to store the received control information,
a power driving unit to control power supplied to the pickup module according to control instructions from the measurement driving unit so as to perform the measurement operations,
an amplifying unit to amplify a signal outputted from the pickup module during the measurement operations,
a plurality of signal processing units to process a signal amplified by the amplifying unit, and
a signal multiplexer to selectively output signals from the signal processing units to said control unit under the control instructions from the measurement driving unit.

6. The pickup inspection apparatus according to claim 5, wherein each of the signal processing units corresponds to a different one of the multiple types of the discs to be read by the pickup module so as to process different signals.

7. The pickup inspection apparatus according to claim 1, further comprising a storage unit to store servo information and measurement information preset according the kinds of discs to be read by the pickup module, wherein said control unit controls said servo unit and said measurement unit according to the stored servo and measurement information in said storage unit in order to measure a focus, a linear velocity and a double-speed of the pickup module used to read data from the test disc.

8. The pickup apparatus according to claim 1, wherein:
the pickup unit includes a first optical pickup that is compatible with one of the types of discs, and a second optical pickup that is compatible with another of the types of discs, and
said control unit:
first activates the first optical pickup and determines a first state of the first optical pickup according to first measurement results received due to the inspection of the pickup module, and
after the first measurement results are received, activates the second optical pickup and determines a second state of the pickup module according to second measurement results.

9. The pickup apparatus according to claim 8, wherein the one type of disc is a digital versatile disc (DVD) and the another type of disc is a compact disc (CD).

10. A pickup module inspection apparatus to inspect a combo-type pickup module that is compatible with different types of discs using corresponding optical pickups, the apparatus comprising:
a machine unit to receive the pickup module to be inspected, to position the pickup module to read data from a received disc, and to rotate the received disc in order to read data from the received disc;
a measuring unit to control the received pickup module to read the data from the received disc and to output measurement information that results from the read data; and
a controller to select one of the optical pickups that is compatible with one of the types of discs but not another of the types of discs, to activate the selected optical pickup, to control said measuring unit and said machine unit to read the data from the received disc using the activated optical pickup, and to compare the output measurement information with predetermined standards corresponding to the selected optical pickup.

11. The pickup module inspection apparatus according to claim 10, wherein said controller further selects another one of the optical pickups that is compatible with the another type of disc and activates the another optical pickup.

12. The pickup module inspection apparatus according to claim 10, wherein said controller sets a light property of the pickup module to correspond with reproducing data from the selected type of disc.

13. The pickup module inspection apparatus according to claim 10, wherein said controller sets a focus property of the pickup module to correspond with reproducing data from the selected type of disc.

14. The pickup module inspection apparatus according to claim 10, wherein said controller sets a tracking property in said machine unit to correspond with reproducing data from the selected type of disc.

15. The pickup module inspection apparatus according to claim 10, wherein said measuring unit comprises a driving unit and a signal processing unit, the driving unit powers the selected optical pickup according to a command from said control unit, and the signal processing unit receives the data read by the selected optical pickup during an the operation sequence and outputs the received data as the output measurement information.

16. The pickup module inspection apparatus according to claim 15, wherein said machine unit comprises a servo driving unit that drives a spindle motor to rotate the received disc and a feed motor to move the received pickup module in order to perform the operation sequence.

17. The pickup module inspection apparatus according to claim 16, wherein:
said machine unit further comprises a servo storage unit to store servo control information, and
the spindle motor, the feed motor, and the pickup module are operated in accordance with the stored servo control information.

18. The pickup module inspection apparatus according to claim 17, wherein the servo control information includes information on focus and light intensity for use by the pickup module, tracking information for use by the feed motor, and linear velocity information for use by the spindle motor.

19. The pickup module inspection apparatus according to claim 18, further comprising a communication unit to receive the servo control information for the selected type of disc from an external device.

20. The pickup module inspection apparatus according to claim 20, wherein the received servo control information is downloaded from the external device.

21. The pickup module inspection apparatus according to claim 18, further comprising an input unit through which a user inputs the servo control information for the selected type of disc.

22. The pickup module inspection apparatus according to claim 18, wherein said controller further selects another one of the optical pickups that is compatible with the another type of disc and activates the another optical pickup.

23. A computer readable medium encoded with processing instructions for implementing a method of inspecting a combo-type pickup module that is compatible with different types of discs using corresponding optical pickups performed by a computer in a pickup module inspection apparatus, the method comprising:
selecting one of the optical pickups that are compatible with different types of discs;
setting a received combo-type pickup module to active the selected optical pickup that is compatible with the one of the types of discs but not with another of the types of discs;
controlling a machine unit to rotate a test disc and to position the received combo-type pickup module to read data from the test disc using the received pickup module;
controlling a measuring unit to receive the data read using the received pickup module, to perform an inspection corresponding to the selected optical picup using the read data, and to output inspection data; and
comparing the inspection data with stored data to determine whether the pickup module has a defect.

24. The computer readable medium according to claim 23, further comprising:
selecting another of the optical pickups that is compatible with the another type of disc;
setting the received combo-type pickup module to activate the selected another optical pickup that is compatible with the another type of disc;
controlling the machine unit to rotate the test disc and to position the received combo-type pickup module to read data from the test disc using the received pickup module with the activated another optical pickup;
controlling the measuring unit to receive the data read using the received pickup module, to perform another inspection corresponding to the selected another optical pickup using the read data, and to output additional inspection data; and
comparing the additional inspection data with additional stored data to determine whether the pickup module has another defect.

25. The computer readable medium according to claim 24, wherein each of the different types of disc uses different light intensity values in order to reproduce data.

26. The computer readable medium according to claim 23, further comprising receiving an inspection sequence corresponding to the selected optical pickup, wherein the inspection sequence is used during said controlling the machine unit and said controlling the measuring unit.

27. The computer readable medium according to claim 26, wherein said receiving the inspection sequence comprises retrieving the inspection sequence from a memory that stores additional inspection sequences corresponding to others of optical pickups.

28. The computer readable medium according to claim 23, wherein said controlling the machine unit further comprises sending servo information corresponding to the selected optical pickup to the machine unit, the servo information comprising information on a laser intensity and focus for use by the pickup module, tracking information for use by a feed motor that moves the received pickup module, and linear velocity information for use by a spindle motor that rotates the test disc.

29. The computer readable medium according to claim 28, wherein said controlling the measuring unit further comprises providing measurement information corresponding to the selected optical pickup, where the measuring unit processes the read data using ones of signal processors in accordance with the provided measurement information, and receiving from the measuring unit the processed data from the ones of the signal processors.

30. The computer readable medium according to claim 29, wherein each of the signal processors performs a corresponding inspection procedure, and the processed data is multiplexed prior to being received from the measuring unit.

31. The computer readable medium according to claim 23, wherein the defect comprises a defect in focus by the received pickup module.

32. The computer readable medium according to claim 23, wherein the defect comprises a defect in linear velocity measurement by the received pickup module.

33. A method of inspecting a combo-type pickup module that is compatible with different types of discs using corresponding optical pickups, the method comprising:
selecting one of the optical pickups that are compatible with different types of discs;
setting a received combo-type pickup module to active the selected optical pickup that is compatible with the one of the types of discs but not with another of the types of discs;
controlling a machine unit to rotate a test disc and to position the received combo-type pickup module to read data from the test disc using the received pickup module;
controlling a measuring unit to receive the data read using the received pickup module, to perform an inspection corresponding to the selected optical picup using the read data, and to output inspection data; and
comparing the inspection data with stored data to determine whether the pickup module has a defect.

34. The method according to claim 33, further comprising:
selecting another of the optical pickups that is compatible with the another type of disc;
setting the received combo-type pickup module to activate the selected another optical pickup that is compatible with the another type of disc;
controlling the machine unit to rotate the test disc and to position the received combo-type pickup module to read data from the test disc using the received pickup module with the activated another optical pickup;
controlling the measuring unit to receive the data read using the received pickup module, to perform another inspection corresponding to the selected another optical pickup using the read data, and to output additional inspection data; and
comparing the additional inspection data with additional stored data to determine whether the pickup module has another defect.

35. The method according to claim 34, wherein each of the different types of disc uses different light intensity values in order to reproduce data.

36. The method according to claim 33, further comprising receiving an inspection sequence corresponding to the selected optical pickup, wherein the inspection sequence is used during said controlling the machine unit and said controlling the measuring unit.

37. The method according to claim 36, wherein said receiving the inspection sequence comprises retrieving the inspection sequence from a memory that stores additional inspection sequences corresponding to others of optical pickups.

38. The method according to claim 33, wherein said controlling the machine unit further comprises sending to the machine unit servo information corresponding to the selected optical pickup, the servo information comprising information on a laser intensity and focus for use by the pickup module, tracking information for use by a feed motor that moves the received pickup module, and linear velocity information for use by a spindle motor that rotates the test disc.

39. The method according to claim 28, wherein said controlling the measuring unit further comprises providing measurement information corresponding to the selected optical pickup, where the measuring unit processes the read data using ones of signal processors in accordance with the provided measurement information, and receiving from the measuring unit the processed data from the ones of the signal processors.

40. The method according to claim 39, wherein each of the signal processors performs a corresponding inspection procedure, and the processed data is multiplexed prior to being received from the measuring unit.

41. The method according to claim 33, wherein the defect comprises a defect in focus by the received pickup module.

42. The method according to claim 33, wherein the defect comprises a defect in linear velocity measurement by the received pickup module.
